(19) United States
(12) Patent Application Publication
(10) Pub. No.: US 2007/0288132 A1
(43) Pub. Date: Dec. 13, 2007

(54) Cooperative swarm of unmanned vehicles

(75) Inventor: Juan F. Lam, Manhattan Beach, CA (US)

Correspondence Address: Raytheon Company;Patent Docket Administration, 2000 E. El Segundo Blvd., E04/N119, P.O. Box 902, El Segundo, CA, 90245-0902, US

(73) Assignee: Raytheon Company

(21) Appl. No.: 11/448,554

(22) Filed: Jun. 7, 2006

(51) Int. Cl. G05D 1/00; G01C 21/00

(52) U.S. Cl. 701/23; 701/213

(57) ABSTRACT

A cooperative swarm of unmanned vehicles includes a plurality of unmanned vehicles, each having a location identification system operable to provide location coordinates; a transceiver operable to send and receive location coordinates via omnipresent signals of opportunity, and a guidance system operable to selectively guide the unmanned vehicle towards an identified target and a specified location within an environment. Access to omnipresent signals of opportunity facilitates transmissions indicative of the identified target and/or location between unmanned vehicles in an environment, e.g., an urban environment, where direct line of sight contact is limited. In a related method, at least one omnipresent signal of opportunity is detected within an environment. Location coordinates are transmitted between unmanned vehicles via the detected signal. Collective evaluation facilitates identification of a target within the environment and, and responsive to such identification, at least a subset of the unmanned vehicles are moved to the target's location.

### FIELD

This invention relates generally to the field of unmanned vehicles, and more specifically to a cooperative swarm of unmanned vehicles utilizing omnipresent signals of opportunity for communication, and a method of controlling such a cooperative swarm of unmanned vehicles.

### BACKGROUND

The use of unmanned vehicles (UVs) is frequently desirable to reduce risks to persons in combat or hostile environments. Such unmanned vehicles may take many forms including ground vehicles and air vehicles. These UVs may be used for reconnaissance and/or may be weaponized to engage in active combat or strike missions.

Traditionally, missions involving UVs have relied on pre-programmed flight paths or drive routes. Such planning and programming requires precise knowledge of the terrain to be navigated as well as the location of the eventual target.

For a variety of different reasons, conventional UVs are often manually controlled or may have their routes adjusted by a remote operator. So as to facilitate this control, the remote operator may view aspects of the UV's journey using cameras or other devices attached to or incorporated as part of the UV.

Unmanned air vehicles, and more specifically cruise missiles, are a particular type of UV that are commonly employed in remote combat operations. The applicability of UVs to date, including cruise missiles, has generally been to situations where the terrain is open. In open, obstacle free environments, line of sight communication links systems have permitted groups of cruise missiles to collectively share information in the identification and destruction of a pre-defined and unobstructed target. Human soldiers have long benefited from similar information sharing, for example in the coordination of search teams. Simply put, whereas a target of interest may avoid a single soldier, avoiding a cooperative team of soldiers is far more difficult. This is due in part to the sharing of information between members of the team.

Such line of sight communication systems are point to point system and are not functional in urban settings where buildings and infrastructure may block line of sight and thus block or reflect the transmission, even though the UVs may be quite close in proximity. However, Increasingly, combat missions are occurring in urban areas and other environments providing limited sight range. Despite the risks in terms of casualties, human soldiers are primarily relied upon as the most effective force for search and secure of an area, or search for and elimination of targets of interest. Although UVs may be employed by these field soldiers, the UVs are once again limited to line of sight operation.

Frequently, urban combat or reconnaissance involves operations in territories that are not native and which are not known in as specific a level of detail as may be truly desired for preprogramming of UVs. In addition it is highly likely that during an urban operation, new information will be obtained by at least one UV that may be of significant material value to at least one other UV.

As line of sight communication is severely limited in an urban environment, direct communication from one UV to another may be impossible or at least severally delayed until direct line of sight between UV members is established. Such a delay may in turn lead to the loss of the target of interest and/or greater human casualty. Further, deployment of a communication infrastructure specifically tailored for the UVs prior to their use in an urban environment may all but eliminates their use as collaborative, real time responders to imminent crisis developments.

Hence, there is a need for a cooperative swarm of UVs capable of operating in urban environments without a direct line of sight between the UV members or controlling operators, that overcomes one or more of the technical problems common to contemporary UV operations.

### SUMMARY

This invention provides a cooperative swarm of unmanned vehicles.

In particular, and by way of example only, according to one embodiment of the present invention, provided is a cooperative swarm of unmanned vehicles. More specifically, in such a swarm there are a plurality of unmanned vehicles, each unmanned vehicle further including a location identification system operable to provide location coordinates; a transceiver operable to send and receive location coordinates via omnipresent signals of opportunity, and a guidance system operable to selectively guide the unmanned vehicle towards an identified target and towards a specified location.

In yet another embodiment, provided is a method of cooperatively controlling a swarm of unmanned vehicles, including providing a plurality of unmanned vehicles in an environment, each unmanned vehicle further including: a location identification system operable to provide location coordinates; a transceiver operable to send and receive location coordinates via omnipresent signals of opportunity; and a guidance system operable to selectively guide the unmanned vehicle towards an identified target and towards the location coordinates transmitted by another unmanned vehicle. The method further includes detecting in the environment at least one omnipresent signal of opportunity; transmitting location coordinates between the unmanned vehicles in the environment by way of the detected omnipresent signal of opportunity; and collectively evaluating the environment to identify a target and a target location, and in response to the identification of a target moving at least a subset of the unmanned vehicles to the target location.

### BRIEF DESCRIPTION OF THE DRAWINGS

FIG. 1 is conceptual view of an environment with omnipresent signals of opportunity and a cooperative swarm of unmanned vehicles, in accordance with an embodiment;

FIG. 2 is a conceptual view of the cooperative swarm of unmanned vehicles within the environment of FIG. 1, in accordance with an embodiment;

FIG. 3 is an enlarged view of a portion of the environment in FIG. 2, further showing transceiver, guidance and location identification systems of two unmanned vehicles, in accordance with an embodiment; and

FIG. 4 is high level flow diagram illustrating at least one method of cooperatively controlling a swarm of unmanned vehicles, in accordance with an embodiment.

### DETAILED DESCRIPTION

Before proceeding with the detailed description, it is to be appreciated that the present teaching is by way of example only, not by limitation. The concepts herein are not limited to use or application with a specific system or method for a cooperative swarm of unmanned vehicles. Thus, although the instrumentalities described herein are for the convenience of explanation, shown and described with respect to exemplary embodiments, it will be appreciated that the principles herein may be applied equally in other types of systems and methods involving cooperative swarms of unmanned vehicles.

Advances in telecommunication systems and information transmission now provide signals of opportunity in nearly all urban environments. More specifically, a user with an appropriate device, such as a cell phone, personal data assistant (PDS) or wireless enabled laptop, may enter an environment and enjoy the omnipresent signals of opportunity provided by these telecommunication systems for making telephone calls and for transferring data to and from different computer systems. These systems include, but are certainly not limited to, the following:

“CDPD” is Cellular Digital Packet Data, a data transmission technology developed for use with cellular phone frequencies between eight hundred and nine hundred MHz to transfer data at up to 19.2 kbit/sec. In a growing number of markets, CDPD is being phased out in favor of GPRS.

“GPRS” is General Packet Radio Service, a mobile data service available to users of GSM mobile phones. It provides moderate speed data transfer by accessing unused TDMA (Time Division Multiple Access) channels in the GSM network.

A “GPS” is a Global Positioning System, a satellite navigation system used to determine one's precise location anywhere on the surface of the earth. At the time of this writing, GPS is the only currently active satellite positioning/navigation system, though other such systems are in development.

“GSM” is the Global System for Mobile Communications, the most popular standard for digital wireless communication in the world. GSM is used by over 1.5 billion people across more than two hundred countries and territories. The widespread usage of the GSM standard permits subscribers to enjoy the use of their equipment in many different parts of the world.

“TDMA” is Time Division Multiple Access, a technology for shared medium (typically radio) networks. It allows several users to share the same frequency by dividing it into different time slots, which in turn are allocated to multiple calls or transmissions.

“Wi-Fi” is a set of product compatibility standards for wireless local area networks based on the IEEE 802.11 specifications, and intended to include the developing successors.

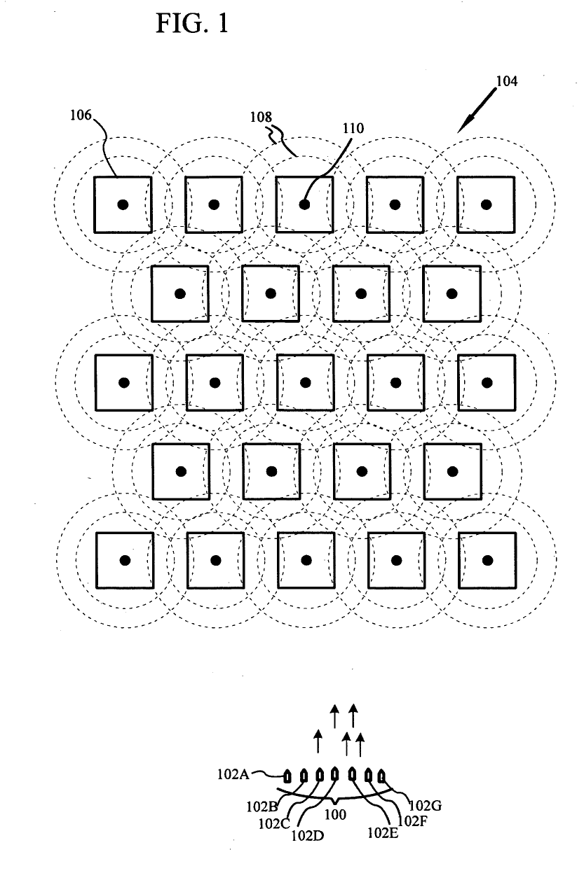

FIG. 1 illustrates an exemplary cooperative swarm 100 of unmanned vehicles (UVs) 102. More specifically, as shown, there are a plurality of UVs 102, of which UVs 102A˜102G are exemplary. The cooperative swarm 100 is moving towards environment 104. Generally, the cooperative swarm may be considered to be active within the environment 104; however, the cooperative swarm 100 is shown removed from the environment in this figure, for ease of identification.

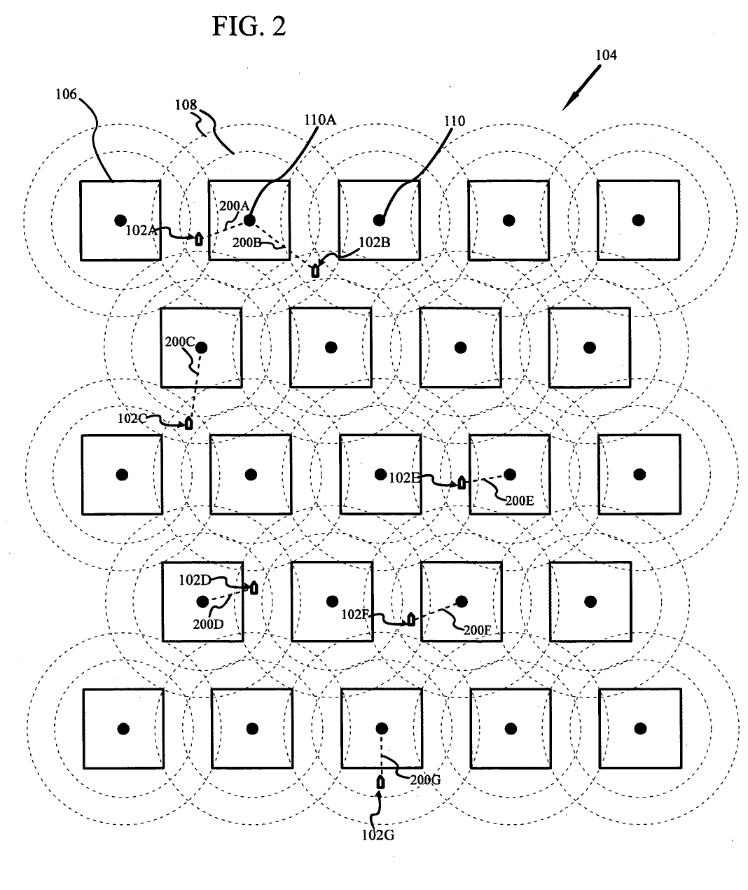

FIG. 2 illustrates the UVs 102 of the cooperative swarm dispersed within the environment 104. The environment 104 in which the UVs 102 are operating is an urban environment consisting of structures 106 which limit direct line of sight.

As is conceptually illustrated in FIGS. 1 and 2, the environment 104 provides omnipresent signals of opportunity 108, illustrated as concentric dotted circles. These omnipresent signals of opportunity 108 are wireless data transmission signals. These data transmission signals and their supporting, pre-existing infrastructure technologies are commonly known to those skilled in the art, and include but are not limited to CDPD, GPRS, GPS, GSM, TDMA, and Wi-Fi.

As is appreciated, transmission bases and repeating stations (e.g. base station transceiver 110) for such data transmission systems are implemented in urban environment 104 to permit users freedom of movement with maintained data transmission throughout the environment 104 without line of sight contact to other sending or receiving parties. For example two persons using cell phones may wander on different streets or travel in different cars throughout the urban environment 104 while in constant communication with one another. As shown, the omnipresent signals of opportunity 108 substantially cover all of the environment 104.

The use of such omnipresent signals of opportunity is highly desirable and advantageous. For example, as such systems are designed and implemented to route communications automatically, it is exceedingly difficult to isolate and terminate individual communications. In addition, modern urban environments are heavily reliant on such systems. Disabling such a system is highly undesirable, as doing so would thwart communications by all parties relying upon the omnipresent signals of opportunity 108.

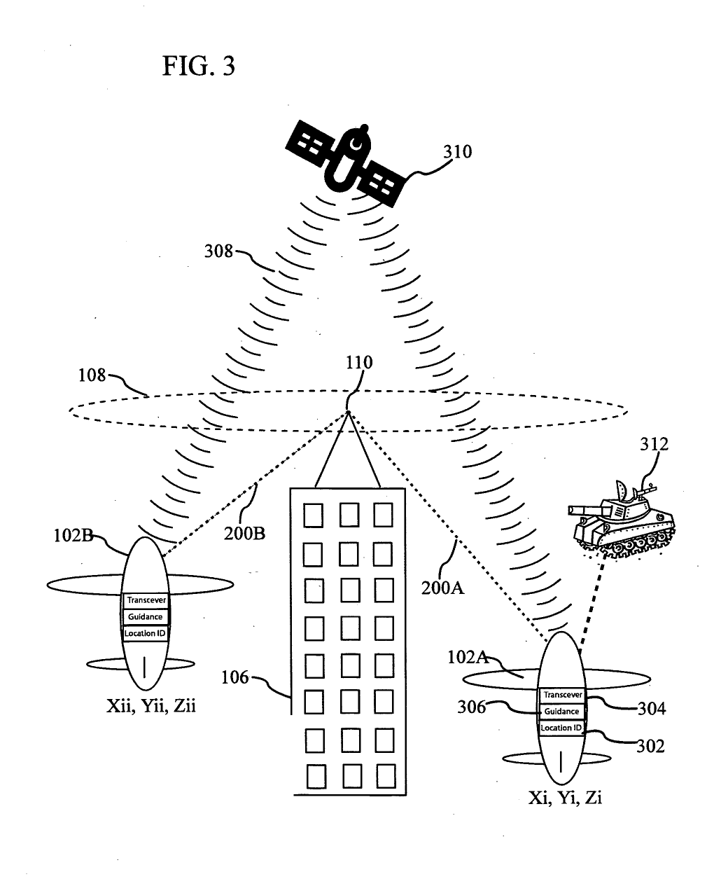

FIG. 3 conceptually illustrates two cooperative UVs 102A and 102B. Each UV 102 includes a location identification system 302, a transceiver 304, and a guidance system 306. The location identification system 302 is operable to provide location coordinates. In at least one embodiment, the location identification system 302 is a GPS system. Receiving signals 308 from satellites 310 (only one shown), the location identification system 302 of UV 102A determines location coordinates, such as for example Xi, Yi, Zi. Similarly, UV 102B determines its location coordinates to be, for example, Xii, Yii, Zii.

The transceiver 304 is operable to send and receive location coordinates via the omnipresent signals of opportunity 108. In at least one embodiment, the transceiver 304 is GSM compliant. As is apparent in FIG. 2, structure 106 is blocking line of sight communication between UV 102A and UV 102B, however the omnipresent signals of opportunity 108 are available to both UV 102A and 102B.

It is understood and appreciated that guidance system 306 is a conventional programmable guidance system that permits the UV to approach one or more target areas and return to base or a designated location for extraction. As those skilled in the art will appreciate, in at least one embodiment, the guidance system 306 has a conventional terrain database that serves to help the UV orient itself during its travel.

The guidance system 306 is operable to guide the UV 102 towards at least one location coordinate. Moreover, the guidance system 306 is operable to selectively guide the UV 102 towards an identified target 312, towards a specified location, and towards the location coordinates transmitted by another UV within the environment 104.

Each UV 102 may also include additional hardware such as video cameras, audio microphones, detectors or other devices. In addition, in at least one embodiment, the UVs 102 of the cooperative swarm are armed with at least one weapon. In an alternative embodiment, the UVs 102 of the cooperative swarm are enabled with a marker device, such as a laser, RF tracker or the like, which may be applied to the target of interest to permit strike weapon targeting.

In at least one embodiment, the UVs 102 are unmanned aerial vehicles or aerial drones, otherwise known as pilotless aircraft. In at least one alternative embodiment, the UVs 102 are unmanned terrestrial vehicles. Unmanned vehicles of both the terrestrial and aerial variety are well known.

The specific type of UVs selected for a mission is to be based on mission parameters and of course the adaptability of each UV to be equipped with the proper location identification system 302, transceiver 304 and interfacing guidance system 306 so as to be a cooperative member of the swarm. It is further appreciated that of a cooperative swarm, some portion of the UVs may be unmanned terrestrial vehicles while others are unmanned aerial vehicles.

With respect to FIGS. 2 and 3, FIG. 3 may be appreciated to be an enlarged portion of environment 104. As noted, structure 106 blocks direct line of sight contact and communication between UVs 102A and 102B. As illustrated, each structure 106 within the environment 104 provides a base station transceiver 110 which provides the omnipresent signals of opportunity 108. This one-to-one pairing of base station transceiver 110 has been selected for ease of illustration, and it is understood that in a real environment the pairing relationships may be different.

As is shown in FIGS. 1 and 2, UV 102A and 102B are exchanging information through indirect communication. UVs 102A and 102B are not in direct communication, but rather are routing their communication through base station transceiver 110A, via communications links 200A and 200B, illustrated by dark dotted lines. Moreover, whereas a walkie-talkie style communication is direct from one transceiver to another transceiver, UVs are communicating through at least one intermediary system—specifically, the base station transceiver 110A providing the omnipresent signals of opportunity 108.

Relying on the omnipresent signals of opportunity 108 as provided by the pre-established base station transceivers 110, it is not necessary for the UVs 102 to have detailed pre-programmed information of each other's whereabouts, or to have high power sophisticated transmission systems. Rather, the technical handling of communications between UVs 102 is offloaded from the UVs 102 to the network infrastructure providing the omnipresent signals of opportunity 108. As shown in FIG. 1, the remaining members of the cooperative swarm, UVs 102C˜102G are each in communication with a proximate base station transceiver, e.g., via communications links 200C˜200G.

For example, in at least one embodiment the omnipresent signals of opportunity within the environment are provided by a GSM cellular phone network. Each UV of the cooperative swarm is equipped with an enabled GSM transceiver. For UV 102A to communicate with UV 102B, UV 102A need only connect to the GSM network and request connection to a GSM ID value (e.g. phone number) of UV 102B. Simultaneous communication between multiple UVs 102 may be established in the same manner as a conference call.

Moreover, as shown in FIG. 2, UVs 102C˜102G are all in cooperative communication as each is adjacent to, and in communication with, at least one base station transceiver 110. In addition, whereas the range of geographical distance between UVs would be a factor of concern in line of sight, point to point, direct communication, the issue of geographical distance between UVs 102 of the cooperative swarm 100 in urban environment 104 is moot, as the communication is achieved through the omnipresent signals of opportunity 108. For UV 102A to communicate with UV 102G requires no more transceiver power than to communicate with UV 102B.

It is certainly understood and appreciated that other networks aside from GSM cellular networks may be advantageously exploited by the UVs 102 of the cooperative swarm. Indeed, in at least one embodiment the omnipresent signals of opportunity are provided by a satellite in orbit. However, the general description provided above remains relevant.

Use of known omnipresent signals of opportunity provides additional advantages as well. For example, for GSM applications, UVs may be equipped with transceivers that are substantially off the shelf components, thus saving on manufacturing and development costs. In at least one embodiment, the transceiver 304 may actually include several different transceiver devices, each operable to communicate via a different type of omnipresent signal of opportunity. In an alternative embodiment, the transceiver 304 may be a tunable device with adaptable programming capable of switching from one type of omnipresent signal to another.

With respect to the communication between the UVs of the cooperative swarm, in at least one embodiment, the communications are handled with traditional network protocols such as, for example, the HyperText Transmission Protocol (“HTTP”), the Wireless Application Protocol (“WAP”), the Handheld Device Transmission Protocol (“HDTP”). Moreover, in at least one embodiment the protocols for communication are selected from group consisting of HTTP, WAP, HDTP, and combinations thereof.

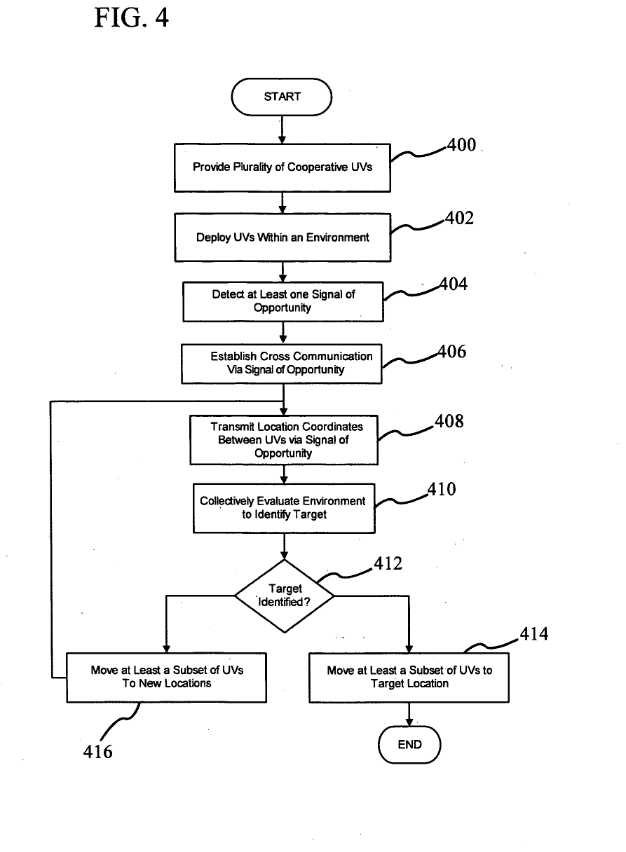

Having described at least one embodiment of the cooperative swarm of UVs, another embodiment is related to the method of cooperatively controlling a swarm of UVs. As will now be discussed with the aid of the flow diagram in FIG. 4, the method of cooperatively controlling the swarm of UVs is advantageous over non-cooperative deployment of UVs or the use of UVs requiring direct line of sight communication between members. It will also be appreciated that the described method need not be performed in the order in which it is herein described, but that this description is merely exemplary of one method of cooperatively controlling a swarm of UVs.

As shown in FIG. 4, the method typically commences with a plurality of UVs being provided, as in block 400. These UVs are understood and appreciated to be substantially identical to UVs 102 as discussed and described above. Specifically, each member of the provided swarm is equipped with at least a location identification system 302, a transceiver 304 and a guidance system 306.

In at least one embodiment, the swarm of UVs 102 are unmanned aerial vehicles, each of which is pre-programmed with the general coordinates of the urban environment into which it will be deployed. Each UV 102 is also provided with specific target information as is known and understood by those skilled in the art. Moreover, a first specified location is predetermined, e.g. the center of the urban environment, and provided to at least a first subset of the UVs. This first subset may be one or all of the UVs.

The swarm of UVs 102 is then deployed into an environment, as in block 402. Once in the environment, the UVs detect within the environment at least one omnipresent signal of opportunity, as in block 404. In at least one embodiment the UV members of the cooperative swarm are equipped with transceivers to detect omnipresent signals of opportunity provided by CDPD, GPRS, GPS, GSM, TDMA, Wi-Fi, and/or combinations thereof.

Once an omnipresent signal of opportunity has been detected, the UVs establish cooperative cross-communication with each other by way of the omnipresent signals of opportunity, as in block 406. As noted above, it is understood and appreciated that the UVs of the cooperative swarm are not in direct point to point communication with one another, but rather are in indirect communication permitted by the omnipresent signals of opportunity and supporting infrastructure. In other words, the cooperative swarm of UVs relay their communications by way of the omnipresent signals of opportunity.

With respect to the omnipresent signals of opportunity and their supporting infrastructure, it is to be understood that this infrastructure is pre-existing, having been established before the cooperative swarm is deployed within the environment. It is of course understood and appreciated that the omnipresent signals of opportunity may be established specifically for the cooperative swarm of UVs; however, in general, the omnipresent signals of opportunity are provided by pre-existing infrastructure technology that is merely exploited by the cooperative swarm of UVs.

The members of the cooperative swarm of UVs transmit their location coordinates to one another, as in block 408. In other words, from the first specified location that was predetermined and programmed into at least a first subset of the UVs, now within the urban environment 104 the UVs exchange their location coordinates. Upon identification of a target, e.g, target 312 (see FIG. 3), a second specified location is provided by at least the one UV having identified the target to at least a subset of the other UV members of the cooperative swarm 100. In such a manner, the cooperative swarm will self adjust their movements towards the specified location of an identified target.

In at least one embodiment, the cooperative swarm is pre-programmed to perform a grid pattern search of the environment 104; each UV member pre-assigned a different starting location. Each member of the cooperative swarm evaluates the portion of the environment proximate to its location and communicates a value, such as for example true or false, in the determination of a proximate target. As indicated above, the transfer of the information (e.g., location coordinates and true or false valuation of a target) is performed in at least one embodiment with the use of known protocols, such as for example, HTTP, WAP, HDTP and combinations thereof.

Moreover, the cooperative swarm of UVs collectively evaluates the environment, as in block 410. If the evaluation is that a target is present, as in decision 412, at least a subset of the UVs is moved to the detected target location, as in block 414. If the evaluation is that a target is not present, as in decision 412, at least a subset of the UVs are moved to new locations within the environment, as in block 416.

For example, and with respect to FIG. 3, UV 102A identifies target 312 and transmits a positive evaluation of the target 312 along with the coordinates Xi, Yi, Zi, by way of the omnipresent signals of opportunity to UV 102B. In response to the positive target evaluation indicated by UV 102A, the guidance system of UV 102B adjusts course to move UV 102B to a location proximate to UV 102A.

It is further appreciated that if target 312 is moving, in at least one embodiment UV 102A is capable of transmitting information indicating the direction of target movement. Based on such information the remaining members of the cooperative swarm may adjust their respective courses to rendezvous at a location determined by the calculation of the respective distance to the target and the target's relative speed and direction.

In at least one embodiment, the transmission of location occurs as a first priority, before an evaluation of the proximate environment is performed. Should the UV be disabled before the evaluation is performed, the loss of communication itself may be evaluated by the remaining members of the cooperative swarm to suggest the presence of a target at the last transmitted location coordinates of the now disabled UV.

It is to be understood that as the cooperative swarm of UVs are unmanned, their size is generally determined by the purpose of their mission. For recognizance, and/or target marking, the UVs may be quite small. For attack, the UVs need only be large enough to accommodate the necessary operational components and weapon of choice.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A cooperative swarm of unmanned vehicles, comprising:
a plurality of unmanned vehicles, each unmanned vehicle further including;
a location identification system operable to provide location coordinates;
a transceiver operable to send and receive the location coordinates via omnipresent signals of opportunity; and
a guidance system operable to selectively guide the unmanned vehicle towards an identified target and towards a specified location.

2. The cooperative swarm of claim 1, wherein the omnipresent signals of opportunity are selected from a group consisting of GPS signals, satellite communications, cellular telephone signals, wireless computer networks, and combinations thereof.

3. The cooperative swarm of claim 1, wherein each unmanned vehicle is an unmanned aerial vehicle.

4. The cooperative swarm of claim 1, wherein each unmanned vehicle is an unmanned terrestrial vehicle.

5. The cooperative swarm of claim 1, wherein the location identification system is GPS.

6. The cooperative swarm of claim 1, wherein the transceiver of each unmanned vehicle is operable to communicate via the omnipresent signals of opportunity provided by CDPD, GPRS, GPS, GSM, TDMA, Wi-Fi, and/or combinations thereof.

7. The cooperative swarm of claim 1, wherein a first specified location is a predetermined set of location coordinates provided to at least a first subset of the unmanned vehicles, a second specified location determined by at least one unmanned vehicle provided to at least a second subset of the unmanned vehicles.

8. The cooperative swarm of claim 1, wherein the specified location is provided as location coordinates by a commanding party.

9. The cooperative swarm of claim 1, wherein each unmanned vehicle further includes at least one target identification device operable to provide a positive or negative evaluation of a proximate target, and wherein the transceiver is further operable to send and receive the positive or negative evaluation of a target.

10. A system for cooperatively directing a swarm of unmanned vehicles, comprising:
an environment providing at least one type of pre-existing omnipresent signals of opportunity;
a plurality of unmanned vehicles, each unmanned vehicle further including;
a location identification system operable to provide location coordinates;
a transceiver operable to send and receive location coordinates via the omnipresent signals of opportunity; and
a guidance system operable to selectively guide the unmanned vehicle towards an identified target, towards a specified location, and towards the location coordinates transmitted by another unmanned vehicle;
wherein each unmanned vehicle is operable to communicate location coordinates to each other unmanned vehicle, the communication performed through the omnipresent signals of opportunity.

11. The system of claim 10, wherein the unmanned vehicles are in indirect communication with one another, the communication permitted by a pre-existing wireless communication system providing the omnipresent signals of opportunity.

12. The system of claim 10, wherein the omnipresent signals of opportunity are selected from a group consisting of GPS signals, satellite communication, cellular telephone signals, wireless computer networks, and combinations thereof.

13. The system of claim 10, wherein each unmanned vehicle further includes at least one target identification device operable to provide a positive or negative evaluation of a proximate target, and wherein the transceiver is further operable to send and receive the positive or negative evaluation of a target.

14. The system of claim 10, wherein the omnipresent signals of opportunity are provided by pre-existing infrastructure within the environment, the transceivers of each unmanned vehicle establishing indirect communication through the pre-existing infrastructure.

15. The system of claim 10, wherein the transceiver of each unmanned vehicle is operable to communicate via the omnipresent signals of opportunity provided by CDPD, GPRS, GPS, GSM, TDMA, Wi-Fi and/or combinations thereof.

16. A method of cooperatively controlling a swarm of unmanned vehicles, comprising:
providing a plurality of unmanned vehicles in an environment, each unmanned vehicle further including;
a location identification system operable to provide location coordinates;
a transceiver operable to send and receive location coordinates via omnipresent signals of opportunity; and
a guidance system operable to selectively guide the unmanned vehicle towards an identified target and towards the location coordinates transmitted by another unmanned vehicle;
detecting in the environment at least one of the omnipresent signals of opportunity;
transmitting location coordinates between the unmanned vehicles in the environment by way of the detected omnipresent signal of opportunity; and
collectively evaluating the environment to identify a target and a target location, and in response to the identification of a target, moving at least a subset of the unmanned vehicles to the target location.

17. The method of claim 16, wherein the omnipresent signals of opportunity are selected from a group consisting of GPS signals, satellite communication, cellular telephone signals, wireless computer networks, and combinations thereof.

18. The method of claim 16, wherein each unmanned vehicle is an unmanned aerial vehicle.

19. The method of claim 16, wherein the location identification system is GPS.

20. The method of claim 16, wherein each unmanned vehicle further includes at least one target identification device operable to provide a positive or negative evaluation of a proximate target, and wherein the transceiver is further operable to send and receive the positive or negative evaluation of a target.

21. The method of claim 16, wherein the transmitting of location coordinates between the unmanned vehicles in the environment occurs as a relay through the omnipresent signals of opportunity rather than direct unmanned vehicle to unmanned vehicle communication.

22. The method of claim 16, wherein the protocols for communication are selected from the group of HTTP, WAP, HDTP, and combinations thereof.

23. The method of claim 16, wherein the transceiver of each unmanned vehicle is operable to communicate via the omnipresent signals of opportunity provided by CDPD, GPRS, GPS, GSM, TDMA, Wi-Fi, and/or combinations thereof.
